(19) United States
(12) Patent Application Publication
(10) Pub. No.: US 2009/0271095 A1
(43) Pub. Date: Oct. 29, 2009

(54) Starting System and Method of Internal Combustion Engine

(75) Inventor: Susumu Kojima, Susono-shi (JP)

Correspondence Address: OLIFF & BERRIDGE, PLC, P.O. BOX 320850, ALEXANDRIA, VA, 22320-4850, US

(73) Assignee: Toyota Jidosha Kabushiki Kaisha, Toyota-shi (JP)

(21) Appl. No.: 11/922,031

(22) PCT Filed: Jun. 7, 2006
(86) PCT No.: PCT/IB2006/001496

§ 371 Date: Dec. 12, 2007

(30) Foreign Application Priority Data
Jun. 16, 2005 (JP) 2005-176794

(51) Int. Cl. F02D 41/06; F02N 17/00; F02M 51/00

(52) U.S. Cl. 701/113; 123/179.3; 123/491

(57) ABSTRACT

Upon a start of the internal combustion engine, a starting system causes an injector to inject fuel into and causes an ignition plug to ignite a mixture in a cylinder stopped in the expansion stroke, and causes the injector to inject fuel into and causes the ignition plug to ignite a mixture at or in the vicinity of the compression TDC in a compression-stroke cylinder that follows the expansion-stroke cylinder. When the engine coolant temperature is equal to or higher than a predetermined temperature, the starting system retards the fuel injection timing for the compression-stroke cylinder.

### TECHNICAL FIELD

The invention relates to starting system and method of an internal combustion engine, in which fuel injection and ignition are performed in a cylinder that is in the expansion stroke, so as to start the engine by using combustion energy resulting from combustion of an air/fuel mixture formed in the expansion-stroke cylinder.

### BACKGROUND ART

In recent years, various technologies for automatically stopping the engine while the vehicle is stopped in an idling state and automatically restarting the engine so as to smoothly start the vehicle have been proposed as methods for reducing or controlling exhaust emissions and improving the fuel economy. With regard to these technologies, if it takes an undesirably long time to restart the engine, the driveability may deteriorate due to a delay in response to the driver's intention of starting, and it is therefore important to quickly restart the engine. Generally, a starter motor is used for starting the engine, which makes it difficult to quickly restart the engine. Furthermore, the above-described technologies require the engine to be frequently stopped and started in a repeated fashion, resulting in reduction of service life of the starter motor and its peripheral parts, and reduction of the amount of electric power charged in the battery due to excessive use of the battery.

In view of the above problems, an engine starting system as disclosed in, for example, Japanese Laid-open Patent Publication No. 2004-301078 may be applied to a direct in-cylinder injection type engine in which fuel is injected directly into a combustion chamber rather than an intake port. The engine starting system operates to inject fuel into a cylinder that is in the expansion stroke and ignite and burn the air/fuel mixture, so as to start the engine with explosive force resulting from the combustion in the expansion-stroke cylinder. The engine starting system disclosed in the above-identified publication actuates a starter from a point of time at which the engine is restarted, and controls the fuel injection timing and ignition timing for a cylinder that is in the compression stroke so that combustion takes place in this cylinder at or after the end of the compression stroke. Furthermore, when the temperature of air in the cylinder is higher than a reference temperature at the time of a restart of the engine, the starting system operates to restrain or inhibit combustion in a cylinder that is in the intake stroke at the time of a stop of the engine.

In order to restart the engine that is in a stopped condition, the conventional starting system performs fuel injection and ignition in the cylinder that is in the expansion stroke, to burn the air/fuel mixture and provide explosive force for giving torque to the engine or crankshaft, and then performs fuel injection and ignition leading to combustion in the cylinder that is in the compression stroke and the cylinder that is in the intake stroke when the crankshaft rotates until the pistons of the compression-stroke cylinder and the intake-stroke cylinder reach predetermined positions. Thereafter, the starting system performs fuel injection and ignition in subsequent cylinders in normal timings so as to restart the engine. If, however, air contained in the cylinders has a high temperature at the time of the restart of the engine, self-ignition may take place after the fuel is injected into a certain cylinder but before the cylinder reaches the predetermined ignition timing. In this case, sufficient start-up torque may not be provided.

In the engine starting system as disclosed in the above-identified publication, when the temperature of air in the cylinders is higher than a reference temperature at the restart of the engine, the controller restrains combustion in the cylinder that is in the intake stroke at the time of stop of the engine, namely, stops or inhibits injection of the fuel into the intake-stroke cylinder and ignition of the air/fuel mixture in this cylinder. If combustion is restrained in the intake-stroke cylinder or the fuel injection and ignition in this cylinder are inhibited, however, a large load is applied to the starter, resulting in an increase of the power consumption and/or reduction of the durability of the starter. Also, self-ignition may take place in a cylinder or cylinders (e.g., a cylinder stopped in the compression stroke), other than the cylinder stopped in the intake stroke. In this case, the engine cannot be appropriately started with high reliability.

### DISCLOSURE OF INVENTION

It is therefore an object of the invention to provide starting system and method of an internal combustion engine, for starting the engine with improved reliability and efficiency while suppressing or preventing self-ignition.

To accomplish the above and/or other object(s), there is provided according to one aspect of the invention a starting system of an internal combustion engine, which comprises: (a) a combustion chamber, (b) an intake port and an exhaust port that communicate with the combustion chamber, (c) an intake valve and an exhaust valve that open and close the intake port and the exhaust port, respectively, (d) fuel injecting means for injecting fuel into the combustion chamber, (e) igniting means for igniting an air/fuel mixture in the combustion chamber, (f) crank angle sensing means for detecting the crank angle of the internal combustion engine, and (g) temperature sensing means for detecting the temperature of the internal combustion engine. In the starting system, control means is provided for determining an expansion-stroke cylinder that is in an expansion stroke at the time of a start of the engine, based on the result of detection of the crank angle sensing means. When the engine starts, the control means causes the fuel injecting means to inject the fuel into the expansion-stroke cylinder, and causes the igniting means to ignite the air/fuel mixture in the expansion-stroke cylinder, while causing the fuel injecting means to inject the fuel into a subsequent cylinder that follows the expansion-stroke cylinder, and causing the igniting means to ignite the air/fuel mixture in the subsequent cylinder at or in the vicinity of the compression top dead center. The control means retards the fuel injection timing for the subsequent cylinder when the temperature of the internal combustion engine detected by the temperature sensing means is equal to or higher than a predetermined temperature.

The starting system according to the above aspect of the invention actuates the fuel injecting means and igniting means upon a start of the engine, so as to perform fuel injection and ignition in the cylinder that is in the expansion stroke and also perform fuel injection and ignition at or in the vicinity of the compression top dead center in the subsequent cylinder following the expansion-stroke cylinder. The starting system is arranged to retard the fuel injection timing for the subsequent cylinder when the temperature of the engine is equal to or higher than the predetermined temperature. Once the engine re-starts by using explosive force resulting from fuel injection, ignition and combustion in the cylinder that is in the expansion stroke, fuel injection and ignition are subsequently carried out in the subsequent cylinder following the expansion-stroke cylinder, for example, the cylinder that is in the compression stroke or the cylinder that is in the intake stroke. While the fuel injected into the subsequent cylinder during the compression stroke is likely to ignite by itself when the engine temperature is high, the starting system of the invention retards the fuel injection timing to a point on or in the vicinity of the top dead center, so as to suppress or prevent self-ignition and thus improve the starting capability, or the reliability and efficiency with which the engine is started.

In one embodiment of the above aspect of the invention, when a compression-stroke cylinder as the subsequent cylinder which is in the compression stroke at the time of a start of the engine is stopped in the latter half of the compression stroke, the control means causes the fuel injecting means to inject the fuel into the compression-stroke cylinder in normal timing regardless of the temperature of the internal combustion engine. In this embodiment, the control means retards the fuel injection timing for the compression-stroke cylinder to a point on or in the vicinity of the compression top dead center when the compression-stroke cylinder is stopped in the first half of the compression stroke and the temperature of the internal combustion engine is equal to or higher than the predetermined temperature.

In the starting system as described above, the control means may retard the fuel injection timing for the compression-stroke cylinder to a point slightly before the compression top dead center when the temperature of the internal combustion engine is equal to or higher than the predetermined temperature.

In another embodiment of the above aspect of the invention, the control means retards the fuel injection timing for an intake-stroke cylinder as the subsequent cylinder which is in an intake stroke at the time of a start of the engine, when the intake-stroke cylinder is stopped in the latter half of the intake stroke and the temperature of the internal combustion engine is equal to or higher than the predetermined temperature.

In a further embodiment of the above aspect of the invention, the control means retards the fuel injection timing for the subsequent cylinder to a point slightly before the compression top dead center when the temperature of the internal combustion engine detected by the temperature sensing means is equal to or higher than a first predetermined temperature, and retards the fuel injection timing for the subsequent cylinder to a point on the expansion stroke after the compression top dead center when the temperature of the internal combustion engine is equal to or higher than a second predetermined temperature that is higher than the first predetermined temperature.

In the embodiment as described just above, when a compression-stroke cylinder as the subsequent cylinder which is in a compression stroke at the time of a start of the engine is stopped in the latter half of the compression stroke, the control means may cause the fuel injecting means to inject the fuel into the compression-stroke cylinder in normal timing regardless of the temperature of the internal combustion engine. Furthermore, the control means may retard the fuel injection timing for the compression-stroke cylinder to a point slightly before the compression top dead center when the compression-stroke cylinder is stopped in the first half of the compression stroke and the temperature of the internal combustion engine is equal to or higher than the first predetermined temperature, and may also retard the fuel injection timing for the compression-stroke cylinder to a point on the expansion stroke after the compression top dead center when the compression-stroke cylinder is stopped in the first half of the compression stroke and the temperature of the internal combustion engine is equal to or higher than the second predetermined temperature.

In any of the embodiments as described above, after retarding the fuel injection timing for the compression-stroke cylinder or the intake-stroke cylinder as the subsequent cylinder, the control means may reset the fuel injection timing for cylinders that follow the compression-stroke cylinder or the intake-stroke cylinder to normal injection timing.

### BRIEF DESCRIPTION OF DRAWINGS

The foregoing and/or further objects, features and advantages of the invention will become more apparent from the following description of exemplary embodiments with reference to the accompanying drawings, in which like numerals are used to represent like elements and wherein:

FIG. 1 is a schematic view showing a starting system of an internal combustion engine constructed according to a first embodiment of the invention;

FIG. 2 is a flowchart illustrating engine stop control and start control performed by the engine starting system of the first embodiment;

FIG. 3 is a schematic view showing the behavior of the pistons and valves in some cylinders, which is observed when the engine stops in the engine starting system of the first embodiment;

FIG. 4 is a schematic view illustrating the fuel injection timing and ignition timing for a cylinder that is stopped in the latter half of the compression stroke;

FIG. 5 is a schematic view illustrating the fuel injection timing and ignition timing for a cylinder that is stopped in the first half of the compression stroke;

FIG. 6 is a flowchart illustrating engine stop control and start control performed by a starting system of an internal combustion engine constructed according to a second embodiment of the invention; and

FIG. 7 is a schematic view illustrating the fuel injection timing and ignition timing for a cylinder that is stopped in the first half of the compression stroke.

### MODES FOR CARRYING OUT THE INVENTION

Starting systems of internal combustion engines as exemplary embodiments of the invention will be described in detail with reference to the drawings. It is, however, to be understood that the invention is not limited to these embodiments.

### First Embodiment

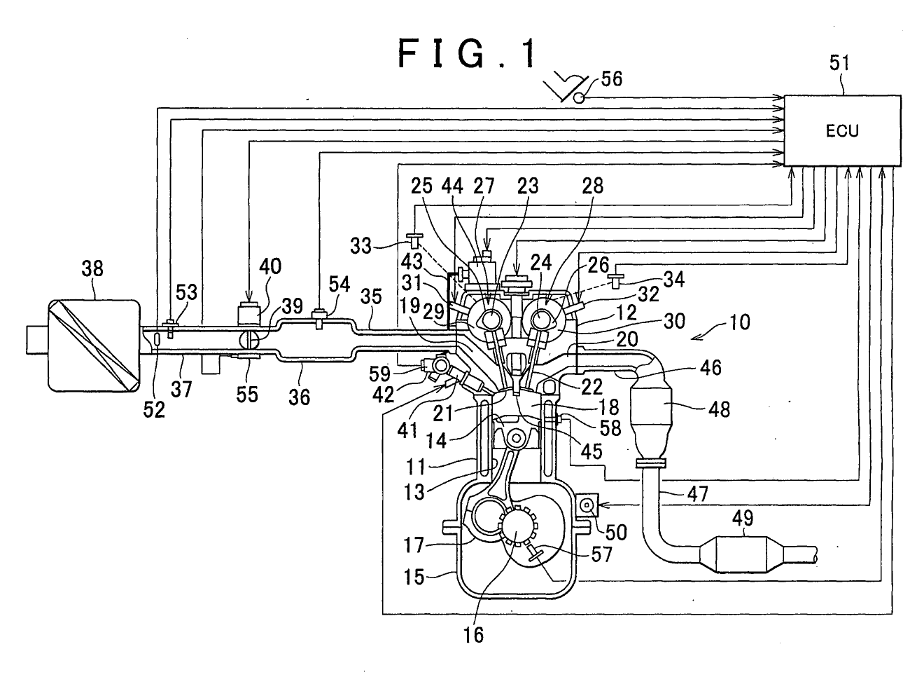

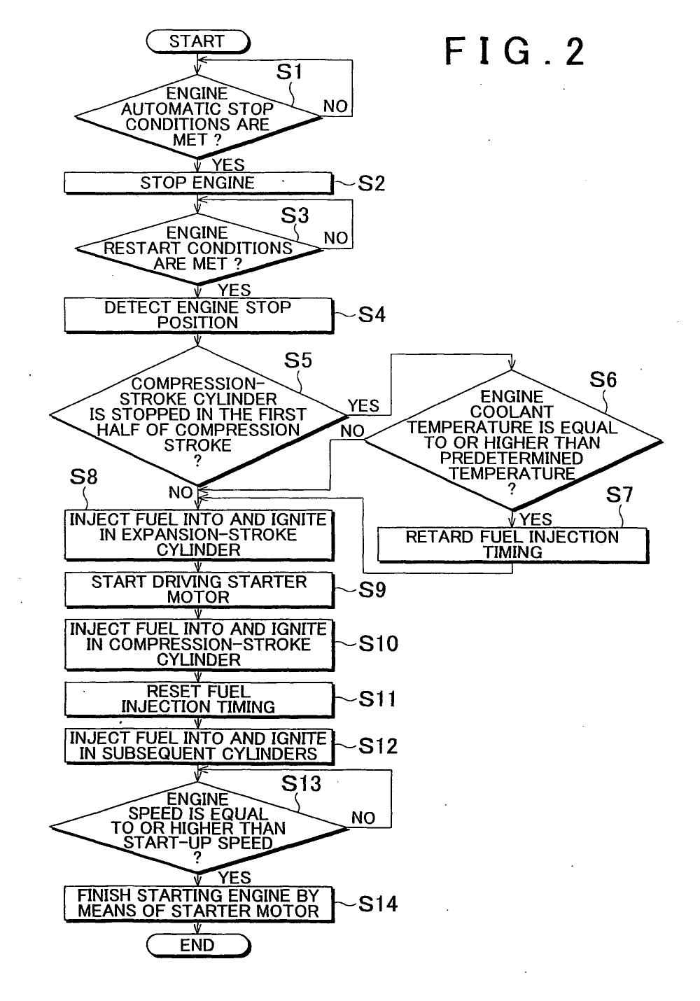

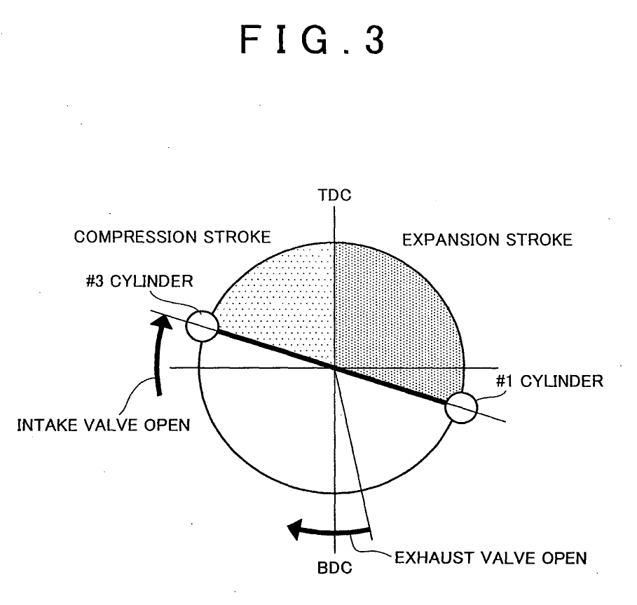

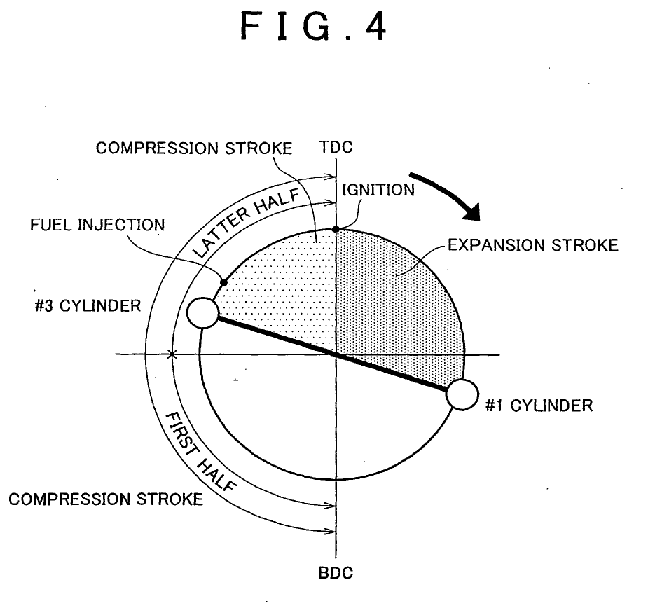

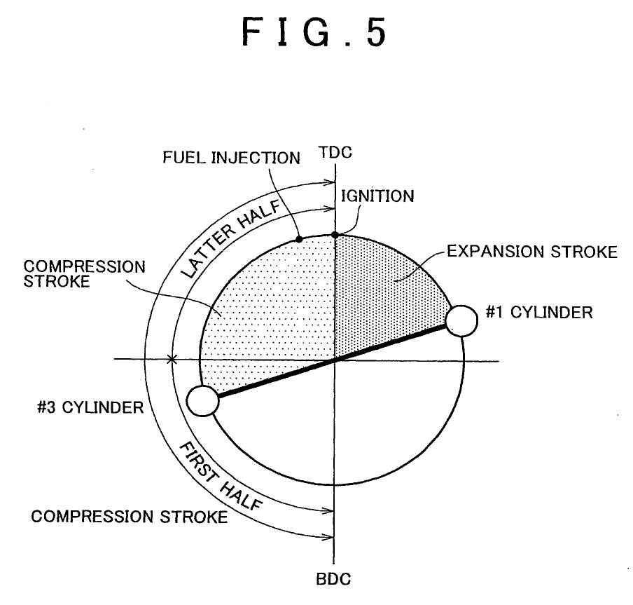

FIG. 1 schematically shows a starting system of an internal combustion engine constructed according to the first embodiment of the invention. FIG. 2 is a flowchart illustrating engine stop control and start control performed by the engine starting system of the first embodiment. FIG. 3 schematically illustrates the behavior of the pistons and valves in some cylinders, which is observed when the engine stops in the engine starting system of the first embodiment. FIG. 4 schematically illustrates the fuel injection timing and ignition timing for a cylinder that is stopped in the latter half of the compression stroke. FIG. 5 schematically illustrates the fuel injection timing and ignition timing for a cylinder that is stopped in the first half of the compression stroke.

The internal combustion engine to which the starting system of the first embodiment is applied is a four-cylinder engine 10 of direct in-cylinder injection type as shown in FIG. 1. The engine 10 includes a cylinder block 11, and a cylinder head 12 fixedly mounted on the cylinder block 11. Pistons 14 are received in cylinder bores 13 formed in the cylinder block 11, such that each of the pistons 14 can move up and down in the corresponding bore 13. A crankcase 15 is fastened to the lower part of the cylinder block 11, and a crankshaft 16 is rotatably supported in the crankcase 15. Each of the pistons 14 is connected to the crankshaft 15 via a connecting rod 17.

Each combustion chamber 18 is defined by the cylinder block 11, cylinder head 12 and the corresponding piston 14. The combustion chamber 18 is shaped like a pentroof, namely, has inclined walls that make a central portion of the upper part of the chamber 18 (i.e., the lower face of the cylinder head 12) higher than the other portions. An intake port 19 and an exhaust port 20 are formed in the upper part of the combustion chamber 18 (i.e., the lower face of the cylinder head 12) such that the intake port 19 is opposed to the exhaust port 20. An intake valve 21 and an exhaust valve 22 are mounted in the cylinder head 12 such that the lower end portions of the intake and exhaust valves 21, 22 are located at the intake port 19 and the exhaust port 20, respectively. The intake valve 21 and the exhaust valve 22 are supported by the cylinder head 12 such that the valves 21, 22 are movable in the axial directions thereof, and are biased in such directions as to close the intake port 19 and the exhaust port 20, respectively. Also, an intake camshaft 23 and an exhaust camshaft 24 are rotatably supported by the cylinder head 12, and an intake cam 25 and an exhaust cam 26 formed on the intake camshaft 23 and the exhaust camshaft 24 are in contact with the upper end portions of the intake valve 21 and exhaust valve 22, respectively, via roller rocker arms (not shown).

With the above arrangement, when the intake camshaft 23 and the exhaust camshaft 24 rotate in synchronism with the crankshaft 16, the intake cam 25 and the exhaust cam 26 actuate the respective roller rocker arms to move the intake valve 21 and the exhaust valve 22 upward and downward in certain timings. With the up-and-down movements of the intake and exhaust valves 21, 22, the intake port 19 and the exhaust port 20 are opened and closed so that the intake and exhaust ports 19, 20 are respectively brought into communication with the combustion chamber 18 and are shut off from the combustion chamber 18.

The engine 10 is equipped with valve systems in the form of intake and exhaust variable valve timing systems (VVT: Variable Valve Timing-intelligent) 27, 28 for controlling the opening and closing timings of the intake valve 21 and exhaust valve 22 to the optimum timings in accordance with the engine operating conditions. The intake and exhaust variable valve timing systems 27, 28 include VVT controllers 29, 30 which are respectively mounted on the axially end portions of the intake camshaft 23 and the exhaust camshaft 24. In operation, hydraulic pressures are applied from oil control valves 31, 32 to selected ones of the advancing chambers and retarding chambers (not shown) of the VVT controllers 29, 30, so as to change the phases of the camshafts 23, 24 relative to the cam sprockets, and thus advance or retard the opening and closing timings of the intake valve 21 and exhaust valve 22. In this case, the intake and exhaust variable valve timing systems 27, 28 advance or retard the opening and closing timings of the intake valve 21 and exhaust valve 22, respectively, while keeping the operation angles (opening periods) of these valves 21, 22 constant. In this connection, the intake camshaft 23 and the exhaust camshaft 24 are respectively provided with cam position sensors 33, 34 for sensing the phases of rotation of the camshafts 23, 24.

The intake port 19 is connected to a surge tank 36 via an intake manifold 35, and an intake pipe 37 is coupled to the surge tank 36. An air cleaner 38 is attached to an air inlet of the intake pipe 37, and an electronic throttle device 40 having a throttle valve 39 is disposed on the downstream side of the air cleaner 38. An injector 41 for injecting the fuel directly into the combustion chamber 18 is mounted in the cylinder head 12, such that the injector 41 is located close to the intake port 19 and is inclined a certain angle with respect to the vertical direction. The injectors 41 provided for the respective cylinders are connected to one another by a delivery pipe 42, and a high-pressure pump 44 is connected to the delivery pipe 42 via a fuel supply pipe 43. To the high-pressure pump 44 are connected a low-pressure pump and a fuel tank via fuel supply pipes (not shown). Furthermore, an ignition plug 45 for igniting an air/fuel mixture is mounted in the cylinder head 12, such that the ignition plug 45 is located upwardly of the combustion chamber 18.

On the other hand, an exhaust pipe 47 is connected to the exhaust port 20 via an exhaust manifold 46, and catalyst devices or catalytic converters 48, 49 for removing or treating harmful substances, such as HC, CO and NOx, contained in exhaust gases are mounted in the exhaust pipe 47. The engine 10 is also provided with a starter motor 50 for starting the engine 10 through cranking. To start the engine 10, a pinion gear (not shown) of the starter motor 50 meshes with a ring gear, and rotary motion or torque is then transmitted from the pinion gear to the ring gear so as to rotate the crankshaft 16.

In the meantime, an electronic control unit (ECU) 51 is installed in the vehicle. The ECU 51 is capable of controlling the injector 41 and the ignition plug 45. More specifically, an air flow meter 52 and an intake air temperature sensor 53 are mounted on the upstream side of the intake pipe 37 while an intake pressure sensor 54 is provided in the surge tank 36, and the specific volume of intake air, intake air temperature and the intake pressure (the intake manifold vacuum) measured by these sensors 52, 53, 54 are transmitted to the ECU 51. A throttle position sensor 55 is mounted in the electronic throttle device 40 and outputs the current throttle opening to the ECU 51, and an accelerator position sensor 56 is provided for outputting the current position of the accelerator pedal to the ECU 51. Furthermore, a crank angle sensor 57 is provided for outputting the detected crank angle of each cylinder to the ECU 51, and the ECU 50 determines which of the intake, compression, expansion (explosion) and exhaust strokes each cylinder is going through, and calculates the engine speed, based on the detected crank angle. In addition, a water temperature sensor 58 is provided in the cylinder block 11 for sensing the engine coolant temperature and outputting the sensed coolant temperature to the ECU 51. A fuel pressure sensor 59 is provided in the delivery pipe 42 that communicates with the respective injectors 41, for sensing the fuel pressure in the pipe 42 and outputting the sensed fuel pressure to the ECU 51.

With the above arrangement, the ECU 51 is operable to drive the high-pressure pump 44 based on the sensed fuel pressure so that the fuel pressure becomes equal to a predetermined pressure level. The ECU 51 is also operable to determine the fuel injection amount, injection timing, ignition timing, and others, based on the engine operating conditions, such as the detected specific volume of intake air, intake air temperature, intake pressure, throttle opening, accelerator pedal position, engine speed, and engine coolant temperature, and drive the injector 41 and the ignition plug 45 so as to carry out injection of the fuel and ignition of the air/fuel mixture.

The ECU 51 is also capable of controlling the intake and exhaust variable valve timing systems 27, 28 based on the engine operating conditions. More specifically, when the engine runs at a low temperature or at a light load, or when the engine starts or runs at idle, the variable valve timing systems 27, 28 are controlled to eliminate an overlap between the opening period of the exhaust valve 22 and the opening period of the intake valve 21 so as to reduce the amount of exhaust gas that flows back to the intake port 19 or the combustion chamber 18, for improvements in the combustion stability and fuel economy or efficiency. When the engine runs at a middle load, the systems 27, 28 are controlled to increase the above-described overlap, thereby to increase the internal EGR rate and enhance the exhaust gas purification (emission control) efficiency while reducing the pumping loss for improved fuel economy. When the engine runs at a high load and a low or middle speed, the ECU 51 operates to advance the closing timing of the intake valve 21 so as to reduce the amount of intake air that flows back into the intake port 19 for improved volumetric efficiency. When the engine runs at a high load and a high speed, the ECU 51 operates to retard the closing timing of the intake valve 21 in accordance with the engine speed, so as to provide valve timing that matches the inertial force of the intake air for improved volumetric efficiency.

The engine 10 constructed as described above has an automatic engine stop function for automatically stopping the engine 10 when the vehicle is stopped in an idling state, and an engine restart function for automatically restarting the engine 10 in response to a start command when the engine 10 is in an automatically stopped state. In this embodiment, when the engine 10 is restarted, a direct in-cylinder injection mechanism is used for starting the engine 10 through ignition and combustion of the air/fuel mixture, in addition to the use of the starter motor 50.

More specifically, after the engine 10 is brought to a stop, the ECU 51 serving as control means determines a cylinder in which the piston 14 is stopped in the expansion stroke, based on the result of detection of the crank angle sensor 57. When the engine 10 is subsequently restarted, the ECU 51 operates to inject the fuel into the cylinder that is stopped in the expansion stroke, and ignite and burn the air/fuel mixture so as to provide explosive force, which is used to move the piston 14 and drive the crankshaft 16. The ECU 51 then operates to drive the starter motor 50 so as to give driving force to the crankshaft 16 and thus restart the engine 10.

In the present embodiment in which the engine 10 is a four-cylinder in-line engine of a direct in-cylinder injection type, when the piston 14 of the first cylinder #1 goes beyond the top dead center (TDC) and stops in the expansion stroke, for example, the piston 14 of the third cylinder #3 following the first cylinder #1 stops in the compression stroke, and the piston 14 of the cylinder (not shown) following the third cylinder #3 stops in the intake stroke, as shown in FIG. 3. In this condition, fuel injection and ignition are performed in the first cylinder #1 stopped in the expansion stroke so that the air/fuel mixture produced in this cylinder burns to provide explosive force, which in turn pushes down the piston 14 of the same cylinder. After the fuel injection and ignition are carried out in the first cylinder #1 stopped in the expansion stroke and the combustion takes place in the same cylinder, the starter motor 50 is driven so that the explosive force of the first cylinder #1 and the driving force of the starter motor 50 cooperate to drive the crankshaft 16 via the piston 14.

The driving force of the crankshaft 16 is then transmitted to the piston 14 of the third cylinder #3 that follows the first cylinder #1 and is stopped in the compression stroke, so as to move this piston 14 upward. In the third cylinder #3 stopped in the compression stroke, when the piston 14 moves up to compress air in the combustion chamber 18, fuel injection and ignition are carried out so that the air/fuel mixture created in the third cylinder #3 burns to provide explosive force, which in turn pushes down the piston 14 of this cylinder. Furthermore, in the cylinder that follows the third cylinder #3 and is stopped in the intake stroke, when the piston 14 moves up to compress air in the combustion chamber 18, fuel injection and ignition are carried out so that the air/fuel mixture created in the intake-stroke cylinder burns to provide explosive force, which in turn pushes down the cylinder 14 of this cylinder. Then, fuel injection and ignition are repeatedly carried out in each of the cylinders following the cylinder stopped in the intake stroke, whereby the engine 10 is restarted. In this specification, the cylinder stopped in the expansion stroke may be referred to as “expansion-stroke cylinder”, and the cylinder stopped in the compression stroke may be referred to as “compression-stroke cylinder” while the cylinder stopped in the intake stroke may be referred to as “intake-stroke cylinder”, when appropriate.

In the present embodiment, when the engine 10 is restarted, injection of the fuel and ignition of the air/fuel mixture are continuously performed at certain crank angles in the cylinders stopped in the expansion stroke, compression stroke and the intake stroke, for example. If air contained in the cylinder stopped in the compression stroke has a high temperature, however, the air/fuel mixture may ignite by itself (i.e., without a spark of the ignition plug) after the fuel is injected into the cylinder but before the predetermined ignition timing is reached, thus making it impossible to provide sufficient start-up torque (i.e., torque for starting the engine 10).

Upon a restart of the engine 10, therefore, the ECU 51 of this embodiment operates to retard the fuel injection timing for a subsequent cylinder that follows the cylinder stopped in the expansion stroke, namely, the cylinder stopped in the compression stroke, when it determines, based on the result of detection of the water temperature sensor 58 as the temperature sensing means, that the engine coolant temperature is equal to or higher than a predetermined temperature. In this case, the fuel injection timing for the compression-stroke cylinder is retarded when the piston 14 of the compression-stroke cylinder is stopped in the first half of the compression stroke AND the engine coolant temperature is equal to or higher than the predetermined temperature.

When the first cylinder #1 is stopped in the latter half of the expansion stroke, and the subsequent third cylinder #3 is stopped in the latter half of the compression stroke, as shown in FIG. 4 by way of example, the fuel is injected into the third cylinder #3 immediately after the crankshaft 16 starts rotating due to explosive force produced in the first cylinder #1, and the air/fuel mixture is ignited at or in the vicinity of TDC. In this case, since the effective compression ratio of the third cylinder #3 is small, the injected fuel hardly ignites by itself even if the engine 10 is at a high temperature, and it is thus unnecessary to retard the fuel injection timing for the third cylinder #3.

On the other hand, when the first cylinder #1 is stopped in the first half of the expansion stroke, and the subsequent third cylinder #3 is stopped in the first half of the compression stroke, as shown in FIG. 5 by way of example, the fuel is injected into the third cylinder #3 slightly before TDC, rather than immediately after the crankshaft 16 starts rotating due to the explosive force produced in the first cylinder #1, and the air/fuel mixture is then ignited. In this case in which the effective compression ratio of the third cylinder #3 is large, if the fuel is injected into the third cylinder #3 immediately after the start of the rotation of the crankshaft 16 with the engine 10 being at a high temperature, the injected fuel is likely to ignite by itself due to its high temperature and high pressure, and it is thus necessary to retard the fuel injection timing for the third cylinder #3.

Referring next to the flowchart of FIG. 2, engine stop control and restart control of the engine starting system of the first embodiment as described above will be described in detail.

As shown in FIG. 1 and FIG. 2, the ECU 51 determines in step SI whether automatic stop conditions for stopping the engine 10 during operation of the vehicle are met. Here, the automatic stop of the engine 10 means stopping the engine 10 while it is idling, or so-called “idle stop”. In this case, the automatic stop conditions include, for example, those in which the vehicle speed is 0 km/h, the brake switch is in the ON state, and the shift lever is kept in the neutral (N) position for a predetermined time. When the vehicle is in these conditions, the ECU 51 determines that the vehicle is stopped, for example, at a red light, and the automatic stop conditions are met. It is, however, to be understood that the engine 10 may be stopped while the vehicle is decelerating. In this case, the automatic stop conditions for stopping the engine 10 may include, for example, those in which the vehicle speed is equal to or lower than a certain speed, the engine speed is equal to or lower than a certain speed, the engine coolant temperature is equal to or lower than a certain temperature level, and the air conditioner is in the OFF state. With the vehicle being in these conditions, the ECU 51 determines that the vehicle is decelerating, and the automatic stop conditions are met.

If it is determined in step S1 that the automatic stop conditions for the engine 10 are met, the ECU 51 proceeds to step S2 to disable the injector 41 from injecting the fuel and disable the ignition plug 45 from igniting the air/fuel mixture, so as to stop the engine 10.

Subsequently, the ECU 51 determines in step S3 whether engine restart conditions are met while the engine 10 is in an automatically stopped state. The restart conditions for the engine 10 may include, for example, those in which the vehicle speed is equal to 0 km/h, the brake switch is in the ON state, and the shift lever is in the running (1, 2, D, or R) position. With these conditions satisfied, the ECU 51 determines that the driver has an intention of starting the vehicle, and the restart conditions are met. If it is determined in step S3 that the conditions for restarting the engine 10 are met, step S4 and subsequent steps are executed to start the engine 10 through ignition and combustion of the air/fuel mixture.

More specifically, prior to a restart of the engine, the ECU 51 determines in step S4 which of the cylinders is stopped in the expansion stroke, based on the result of detection of the crank angle sensor 57. In step S5, the ECU 51 determines whether the cylinder stopped in the compression stroke is stopped in the first half of the compression stroke. If step S5 determines that the compression-stroke cylinder is not stopped in the first half of the compression stroke, the ECU 51 proceeds to step S8 without making the setting for retarding the fuel injection timing for the cylinder stopped in the compression stroke. If step S5 determines that the compression-stroke cylinder is stopped in the first half of the compression stroke, on the other hand, the ECU 51 proceeds to step S6.

In step S6, the ECU 51 determines whether the engine coolant temperature measured by the water temperature sensor 58 is equal to or higher than a predetermined temperature. If step S6 determines that the engine coolant temperature is not equal to or higher than (i.e., is lower than) the predetermined temperature, the ECU 51 proceeds to step S8 without making the setting for retarding the fuel injection timing for the cylinder stopped in the compression stroke. If step S6 determines that the engine coolant temperature is equal to or higher than the predetermined temperature, on the other hand, the ECU 51 executes step S7 to make the setting for retarding the fuel injection timing for the cylinder stopped in the compression stroke, and then proceeds to step S8.

Through the operations of steps S5, S6 and S7 as described above, the ECU 51 makes the setting for retarding the fuel injection timing for the compression-stroke cylinder when this cylinder is stopped in the first half of the compression stroke AND the engine coolant temperature is equal to or higher than the predetermined temperature. The ECU 51 then proceeds to step S8 in which a certain amount of fuel is injected from the injector 41 into the combustion chamber 18 of the cylinder stopped in the expansion stroke, and the air/fuel mixture is then ignited by the ignition plug 45, so that the mixture starts burning to provide explosive force for moving the piston 14 downward. In the following step S9, start-up of the engine 10 by means of the starter motor 50 is initiated immediately after the combustion takes place in the expansion-stroke cylinder.

When the air/fuel mixture in the expansion-stroke cylinder starts burning and substantially at the same time the starter motor 50 is driven, the piston 14 of the expansions-stoke cylinder moves downward to rotate the crankshaft 16, and the torque thus produced is transmitted to the cylinder following the expansion-stroke cylinder, i.e., the cylinder stopped in the compression stroke. As a result, the piston 14 of the compression-stroke cylinder moves upward, and the compression stroke is resumed. In step S10, a certain amount of fuel is injected at a suitable point of time from the injector 41 into the cylinder stopped in the compression stroke, and the air/fuel mixture is then ignited by the ignition plug 45, so that the mixture starts burning to provide explosive force for moving the piston 14 downward.

In the case where the compression-stroke cylinder is stopped in the latter half of the compression stroke, or the engine coolant temperature is lower than the predetermined temperature, the fuel injection timing for the compression-stroke cylinder is not set or arranged to be retarded; therefore, the fuel is injected from the injector 41 immediately after the rotation of the crankshaft 16 starts due to the explosive force produced in the expansion-stroke cylinder, and the air/fuel mixture is then ignited at or in the vicinity of TDC.

On the other hand, in the case where the compression-stroke cylinder is stopped in the first half of the compression stroke AND the engine coolant temperature is equal to or higher than the predetermined temperature, the fuel injection timing for the compression-stroke cylinder is set or arranged to be retarded; therefore, the fuel is injected when the piston 14 of the compression-stroke cylinder is located slightly before TDC after the rotation of the crankshaft 16 starts due to the explosive force of the expansion-stroke cylinder, and the air/fuel mixture is then ignited. With this arrangement, injection of the fuel and ignition are successively carried out in the vicinity of TDC, which can prevent the air/fuel mixture whose temperature and pressure have been raised to high levels from igniting by itself during the compression stroke. Thereafter, step S11 is executed to reset the fuel injection timing to normal timing suitable for the operating conditions of the engine 10.

In step S12, air is inducted or drawn from the intake port 19 into each of the cylinders following the cylinders stopped in the expansion stroke and compression stroke. Then, a certain amount of fuel is injected from the injector 41 into each of the subsequent cylinders, and the air/fuel mixture is ignited by the ignition plug 45 so that the mixture burns and provides explosive force for moving the piston 14 downward. The air induction, fuel injection and ignition for the subsequent cylinders are performed in normal manners. Thus, the subsequent cylinders continue to produce explosive force for a certain period of time while the starter motor 50 produces driving force, so that the engine 10 is restarted with the driving force and the explosive force.

Subsequently, it is determined in step S13 whether the engine speed has risen to a predetermined start-up speed or higher. If the engine speed becomes equal to or higher than the start-up speed, the ECU 51 proceeds to step S14 to finish start-up of the engine 10 by means of the starter motor 50. Thus, the engine 10 is restarted in an appropriate manner.

In the engine starting system of the first embodiment as described above, upon a start-up of the engine 10, injecting the fuel by the injector 41 and igniting the mixture by the ignition plug 45 are performed in the cylinder stopped in the expansion stroke, and injecting the fuel by the injector 41 and igniting the mixture at or in the vicinity of the compression TDC by the ignition plug 45 are performed in the cylinder following the expansion-stroke cylinder, namely, the cylinder stopped in the compression stroke, so that the engine 10 can be started. If the engine coolant temperature is equal to or higher than the predetermined temperature, the fuel injection timing for the cylinder stopped in the compression stroke is set or arranged to be retarded.

Thus, when the engine 10 restarts or initiates start-up with the explosive force resulting from the fuel injection, ignition and combustion in the cylinder stopped in the expansion stroke, the fuel is then injected into and ignited in the subsequent cylinder following the expansion-stroke cylinder, i.e., the cylinder stopped in the compression stroke. At this time, if the engine coolant temperature is equal to or higher than the predetermined temperature, the fuel injection timing for the cylinder stopped in the compression stroke is retarded. More specifically, the fuel is injected into the compression-stroke cylinder when the piston 14 of this cylinder is located slightly before TDC after the rotation of the crankshaft 16 starts due to the explosive force produced in the expansion-stroke cylinder, and the air/fuel mixture is then ignited. Thus, the starting system of this embodiment can prevent the air/fuel mixture having a high temperature and a high pressure from igniting by itself during the compression stroke, thus assuring improved starting capability, namely, improved reliability and efficiency with which the engine 10 is started.

In the first embodiment as described above, when the compression-stroke cylinder is stopped in the first half of the compression stroke AND the engine coolant temperature is equal to or higher than the predetermined temperature, the fuel injection timing for the compression-stroke cylinder is set or arranged to be retarded. Accordingly, the fuel droplets sprayed into the cylinder stopped in the compression stroke are surely prevented from rising in temperature and pressure and igniting by itself during the compression stroke.

Furthermore, in the illustrated embodiment, after retarding the fuel injection timing for the cylinder stopped in the compression stroke, the fuel injection timing for the subsequent cylinders following the compression-stroke cylinder is reset to certain timing suitable for the engine operating conditions. Accordingly, the subsequent cylinders following the compression-stroke cylinder are less likely to suffer from poor combustion.

### Second Embodiment

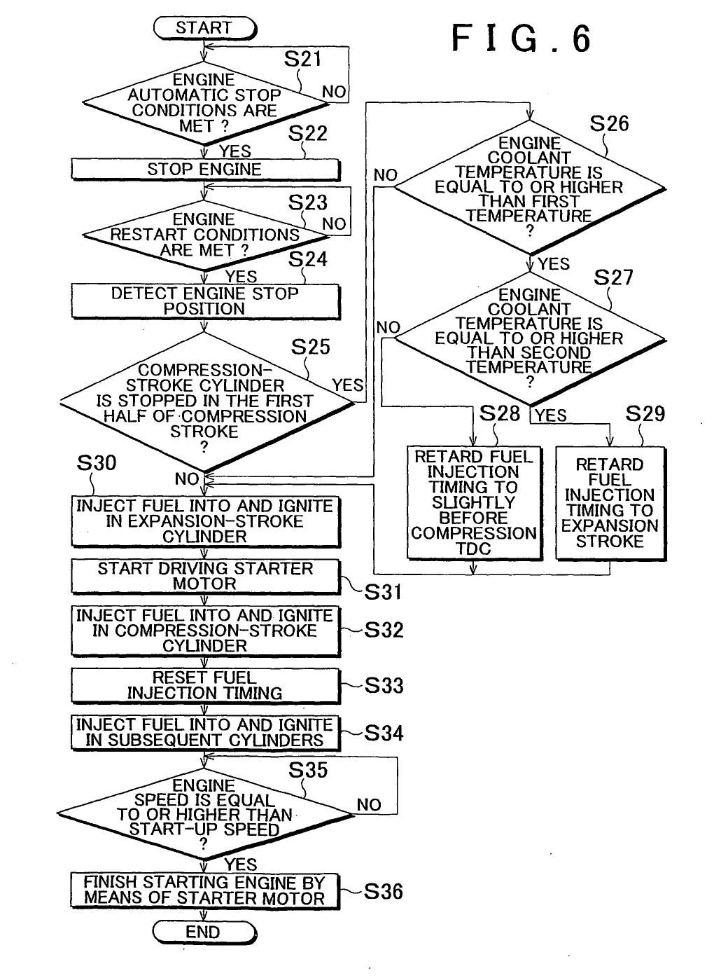

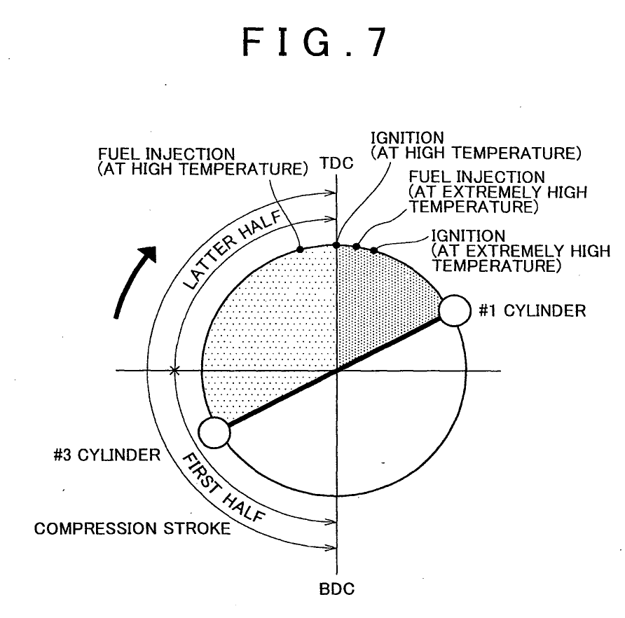

FIG. 6 is a flowchart illustrating engine stop control and start control performed by a starting system of an internal combustion engine as the second embodiment of the invention. FIG. 7 schematically illustrates the fuel injection timing and ignition timing for a cylinder that is stopped in the first half of the compression stroke. The whole construction of the engine starting system of this embodiment is substantially the same as that of the first embodiment as described above, and will be described with reference to FIG. 1. In the following description, the same reference numerals as used in the explanation of the first embodiment will be used for identifying structurally and/or functionally corresponding elements, of which detailed description will not be provided.

Like the engine starting system of the first embodiment as described above, the engine starting system of the second embodiment has the function of automatically stopping the engine 10 when the vehicle is stopped in an idling state, and the function of automatically restarting the engine 10 in response to a start command while the engine 10 is in an automatically stopped state, as shown in FIG. 1. More specifically, after the engine 10 is stopped, the ECU 51 determines the cylinder in which the piston 14 is stopped in the expansion stroke. Upon a restart of the engine 10, the ECU 51 operates to inject fuel into the cylinder stopped in the expansion stroke, and ignite and burn the air/fuel mixture to provide explosive force, which is used to move the piston 14 and drive the crankshaft 16. The ECU 51 then operates to drive the starter motor 50 so as to give driving force to the crankshaft 16, thereby to restart the engine 10.

In the present embodiment, if the ECU 51 determines, on the basis of the result of detection of the water temperature sensor 58, that the engine coolant temperature is equal to or higher than a predetermined first temperature when the engine 10 is restarted, the fuel injection timing for the subsequent cylinder following the expansion-stroke cylinder, i.e., the cylinder stopped in the compression stroke, is retarded to a point slightly before the compression top dead center (TDC). If the engine coolant temperature is equal to or higher than a predetermined second temperature at the time of the restart of the engine 10, the fuel injection timing for the cylinder stopped in the compression stroke is retarded to a point on the expansion stroke after the compression top dead center (TDC). More specifically, when the compression-stroke cylinder is stopped in the first half of the compression stroke, the fuel injection timing for the compression-stroke cylinder is retarded to a point slightly before the compression top dead center (TDC) if the engine coolant temperature is equal to or higher than the first temperature, and the fuel injection timing for the same cylinder is retarded to be a point on the expansion stroke after the compression top dead center (TDC) if the engine coolant temperature is equal to or higher than the second temperature that is higher than the first temperature.

As shown in FIG. 7, if the first cylinder #1, for example, is stopped in the first half of the expansion stroke while the following third cylinder #3 is stopped in the first half of the compression stroke, and the engine coolant temperature is equal to or higher than the first temperature, the fuel is injected into the third cylinder #3 at a point slightly before TDC, rather than immediate after the rotation of the crankshaft 16 starts due to the explosive force produced in the first cylinder #1, and the air/fuel mixture is then ignited. In this case, if the fuel is injected into the third cylinder #3 immediately after the start of rotation of the crankshaft 16, the duration between the injection of the fuel into the third cylinder #3 and TDC (the time at which the third cylinder #3 reaches TDC) is undesirably long, and the injected fuel is likely to rise in temperature and pressure and ignite by itself in this duration where the engine 10 is at a high temperature. In this case, therefore, there is a need to retard the fuel injection timing to a point slightly before the ignition timing or the moment of ignition.

If the first cylinder #1 is stopped in the first half of the expansion stroke while the subsequent third cylinder #3 is stopped in the first half of the compression stroke, and the engine coolant temperature is equal to or higher than the second temperature, the fuel is injected into the third cylinder #3 in the expansion stroke after TDC, and the air/fuel mixture is then ignited. In the case where the engine 10 is at an extremely high temperature, as in this case, the temperature and pressure of the injected fuel are immediately raised and self-ignition of the fuel is likely to occur even if the fuel is injected in the latter half of the compression stroke. It is, therefore, necessary to retard the fuel injection timing to a point on the expansion stroke at which the temperature and pressure in the cylinder have been lowered to some extent.

Referring to the flowchart of FIG. 6, the engine stop control and restart control performed by the engine starting system of the second embodiment as described above will be described in detail.

As shown in FIG. 1 and FIG. 6, the ECU 51 determines in step S21 whether automatic stop conditions for automatically stopping the engine 10 are met during operation of the vehicle. If it is determined in step S21 that the automatic stop conditions for the engine 10 are met, the ECU 51 proceeds to step S22 to disable the injector 41 from injecting fuel and disable the ignition plug 45 from igniting the air/fuel mixture, so as to stop the engine 10.

Subsequently, it is determined in step S23 whether engine restart conditions are met while the engine 10 is in an automatically stopped state. If it is determined in step S23 that the engine restart conditions for the engine 10 are met, step S24 and subsequent steps are executed to start the engine 10 through ignition and combustion of the air/fuel mixture.

More specifically, the ECU 51 determines in step S24 which of the cylinders is stopped in the expansion stroke, based on the result of detection of the crank angle sensor 57. In step S25, the ECU 51 determines whether the cylinder that is stopped in the compression stroke is stopped in the first half of the compression stroke. If it is determined in step S25 that the compression-stroke cylinder is not stopped in the first half of the compression stroke, the ECU 51 proceeds to step S30 without making the setting for retarding the fuel injection timing for the cylinder stopped in the compression stroke. If it is determined in step S25 that the compression-stroke cylinder is stopped in the first half of the compression stroke, on the other hand, the ECU 51 proceeds to step S26.

In step S26, the ECU 51 determines whether the engine coolant temperature measured by the water temperature sensor 58 is equal to or higher than a predetermined first temperature. If it is determined in step S26 that the engine coolant temperature is not equal to or higher than (i.e., is lower than) the first temperature, the ECU 51 proceeds to step S30 without making the setting for retarding the fuel injection timing for the cylinder stopped in the compression stroke. If it is determined in step S26 that the engine coolant temperature is equal to or higher than the first temperature, on the other hand, the ECU 51 proceeds to step S27. In step S27, the ECU 51 determines whether the engine coolant temperature measured by the water temperature sensor 58 is equal to or higher than a predetermined second temperature. If it is determined in step S27 that the engine coolant temperature is not equal to or higher than (i.e., is lower than) the second temperature, the ECU 51 makes the setting in step S28 for retarding the fuel injection timing for the compression-stroke cylinder to a point slightly before TDC, and then proceeds to step S30. If it is determined in step S27 that the engine coolant temperature is equal to or higher than the second temperature, on the other hand, the ECU 51 makes the setting in step S29 for retarding the fuel injection timing for the compression-stroke cylinder to a point on the expansion stroke after TDC, and then proceeds to step S30. At the same time, the ignition timing is also retarded in accordance with retarding of the fuel injection timing.

Through the operations of steps S25-S29, if the cylinder stopped in the compression stroke is stopped in the first half of the compression stroke AND the engine coolant temperature is equal to or higher than the first temperature but is lower than the second temperature, the ECU 51 makes the setting for retarding the fuel injection timing for the compression-stroke cylinder to a point slightly before TDC, and then proceeds to step S30. If the cylinder stopped in the compression stroke is stopped in the first half of the compression stroke AND the engine coolant temperature is equal to or higher than the second temperature, the ECU 51 makes the setting for retarding the fuel injection timing for the compression-stroke cylinder to a point on the expansion stroke after TDC, and then proceeds to step S30. In step S30, a certain amount of fuel is injected from the injector 41 into the combustion chamber 18 of the cylinder stopped in the expansion stroke, and the air/fuel mixture is then ignited by the ignition plug 45 so that the mixture burns in this cylinder to provide explosive force for moving the piston 14 downward. In step S31, the ECU 51 starts driving the starter motor 50 for start-up of the engine 10 immediately after the piston 14 of the expansion-stroke cylinder starts moving downward.

With the combustion taking place in the expansion-stroke cylinder and the starter motor 50 being driven, the piston 14 of the expansion-stroke cylinder moves downward to rotate the crankshaft 16, and the rotary motion or torque thus produced is transmitted to the cylinder following the expansion-stroke cylinder, i.e., the cylinder stopped in the compression stroke, so that the piston 14 of the compression-stroke cylinder moves upward for commencement of the compression stroke. In step S32, a certain amount of fuel is injected at a suitable point of time from the injector 41 into the compression-stroke cylinder, and the air/fuel mixture is then ignited by the ignition plug 45 so that the mixture starts burning in the cylinder so as to provide explosive force for moving the piston 14 downward.

In the case where the cylinder stopped in the compression stroke is stopped in the latter half of the compression stroke, or the engine coolant temperature is lower than the first temperature, the fuel injection timing for the compression-stroke cylinder is not set to be retarded; therefore, the fuel is injected from the injector 41 into the compression-stroke cylinder immediately after the rotation of the crankshaft 16 starts due to the explosive force produced in the expansion-stroke cylinder, and the air/fuel mixture is ignited at or in the vicinity of TDC.

On the other hand, in the case where the compression-stroke cylinder is stopped in the first half of the compression stroke AND the engine coolant temperature is equal to or higher than the first temperature but is lower than the second temperature, the fuel injection timing for the compression-stroke cylinder is set to be retarded to a point slightly before TDC. In this case, the fuel is injected into the compression-stroke cylinder when the piston 14 is located slightly ahead of TDC after the rotation of the crankshaft 16 starts due to the explosive force produced in the expansion-stroke cylinder, and the air/fuel mixture is then ignited. Thus, when the engine is in a high-temperature condition, the injection of the fuel and the ignition are successively carried out in the vicinity of TDC, which makes it possible to prevent the air/fuel mixture having a high temperature and a high pressure from igniting by itself during the compression stroke.

Furthermore, in the case where the compression-stroke cylinder is stopped in the first half of the compression stroke AND the engine coolant temperature is equal to or higher than the second temperature, the fuel injection timing for the compression-stroke cylinder is set to be retarded to a point on the expansion stroke after TDC. In this case, the fuel is injected into the compression-stroke cylinder when the piston 14 is located in the expansion stroke after TDC after the rotation of the crankshaft 16 starts due to the explosive force produced in the expansion-stroke cylinder, and the air/fuel mixture is then ignited. Thus, when the engine 10 is in an extremely high-temperature condition, the fuel injection and ignition are carried out in the cylinder which is on the expansion stroke after TDC and in which the temperature and pressure have been lowered, thus making it possible to prevent the air/fuel mixture having a high temperature and a high pressure from igniting by itself during the compression stroke.

Subsequently, step S33 is executed to reset the fuel injection timing and the ignition timing to normal timings suitable for the operating conditions of the engine 10. In step S34, air is inducted from the intake port 19 into each of the cylinders following the cylinders stopped in the expansion stroke and compression stroke. Then, a certain amount of fuel is injected from the injector 41 into each of the subsequent cylinders, and the air/fuel mixture is ignited by the ignition plug 45 so that the mixture burns and provides explosive force for moving the piston 14 downward. The air induction, fuel injection and ignition for the subsequent cylinders are performed in normal manners. Thus, the subsequent cylinders continue to produce explosive force for a certain period of time while the starter motor 50 produces driving force, so that the engine 10 is restarted with the driving force and the explosive force.

Subsequently, it is determined in step S35 whether the engine speed has risen to a predetermined start-up speed or higher. If the engine speed becomes equal to or higher than the start-up speed, the ECU 51 proceeds to step S36 to finish start-up of the engine 10 by means of the starter motor 50. Thus, the engine 10 is restarted in an appropriate manner.

In the engine starting system of the second embodiment, upon a start of the engine 10, injecting the fuel by the injector 41 and igniting the mixture by the ignition plug 45 are performed in the cylinder stopped in the expansion stroke, and injecting the fuel by the injector 41 and igniting the mixture at or in the vicinity of the compression TDC by the ignition plug 45 are performed in the cylinder following the expansion-stroke cylinder, namely, the cylinder stopped in the compression stroke, so that the engine 10 can be started. If the compression-stroke cylinder is stopped in the first half of the compression stroke, and the engine coolant temperature is equal to or higher than the first temperature but is lower than the second temperature, the fuel injection timing for the compression-stroke cylinder is retarded to a point slightly before TDC. If the engine coolant temperature is equal to or higher than the second temperature, the fuel injection timing for the compression-stroke cylinder is retarded to a point on the expansion stroke after TDC.

With the above arrangement, when the engine 10 restarts or initiates start-up with the explosive force resulting from the fuel injection, ignition and combustion in the expansion-stroke cylinder, the fuel is injected into and ignited in the cylinder following the expansion-stroke cylinder, i.e., the cylinder stopped in the compression stroke, such that the fuel injection timing for the compression-stroke cylinder is retarded to a point on the expansion stroke when the engine coolant temperature is equal to or higher than the second temperature, namely, when the engine 10 is in an extremely high-temperature condition. Since the fuel is injected into the cylinder in which the temperature and pressure have been lowered to some extent, the starting system of this embodiment can prevent the air/fuel mixture that would have a high temperature and a high pressure from igniting by itself during the compression stroke, thus assuring improved starting capability, namely, improved reliability and efficiency with which the engine 10 is started.

In the illustrated embodiments, upon a restart of the engine 10, the fuel injection, ignition and combustion successively take place at certain crank angles in the cylinders stopped in the expansion stroke, compression stroke and the intake stroke, respectively, such that the fuel injection timing for the compression-stroke cylinder is retarded when the compression-stroke cylinder is stopped in the first half of the compression stroke AND the engine coolant temperature is equal to or higher than the predetermined temperature (first temperature). In a modified embodiment, the fuel injection timing for the cylinder stopped in the compression stroke may be retarded when the cylinder stopped in the intake stroke, which follows the compression-stroke cylinder, is stopped in the latter half of the intake stroke AND the engine coolant temperature is equal to or higher than a predetermined temperature. In another modified embodiment, the fuel injection timing for the cylinder stopped in the intake stroke may be retarded when the intake-stroke cylinder is stopped in the latter half of the intake stroke AND the engine coolant temperature is equal to or higher than a predetermined temperature.

Namely, when the intake-stroke cylinder that follows the compression-stroke cylinder is stopped in the first half of the intake stroke, the intake valve 22 is still open, and fresh air is introduced into the intake-stroke cylinder. Therefore, the temperature of the air/fuel mixture to be formed in this cylinder is not elevated to such a high level at which self-ignition takes place, and there is no need to retard the fuel injection timing. When the intake-stroke cylinder is stopped in the latter half of the intake stroke, on the other hand, the intake valve 22 has been at least partially closed, and fresh air is not sufficiently introduced into the intake-stroke cylinder. In this case, the air/fuel mixture to be formed in this cylinder is likely to ignite by itself due to its high temperature and high pressure, and it is thus necessary to retard the fuel injection timing.

In the illustrated embodiments, when the engine 10 is restarted, the fuel is injected into the combustion chamber 18 of the cylinder stopped in the expansion stroke, and the air/fuel mixture in the same cylinder is ignited and burned. In this case, the amount of the injected fuel may be set based on the crank angle at which the engine 10 is stopped, the engine coolant temperature, and the pressure in the crankcase. Since the volume of the combustion chamber 18 is derived from the crank angle at which the engine 10 is stopped, and the air density is derived from the engine coolant temperature, while the pressure in the cylinder is derived from the pressure in the crankcase, the amount of the injected fuel can be set to the optimum value on the basis of these data.

While the engine starting system of the invention is in the form of a restarting system for restarting the engine 10 that has been automatically stopped in the illustrated embodiments, the invention may be equally applied to a starting system for starting the engine 10 in response to the manipulation of the ignition key switch, from a condition in which the engine 10 is completely stopped.

While the engine starting system of the invention is employed in the four-cylinder engine of direct in-cylinder injection type, the invention is not limitedly applied to this type of engine, but may be applied to six-cylinder or other multi-cylinder engines or in-line or V-type engines.

### INDUSTRIAL APPLICABILITY

In the internal combustion engine that starts by using explosive force resulting from fuel injection, ignition and combustion in a cylinder that is in the expansion stroke at the time of start of the engine, the starting system according to the invention operates to retard the fuel injection timing for a subsequent cylinder that follows the expansion-stroke cylinder when the engine temperature is equal to or higher than a predetermined temperature, so as to suppress or avoid occurrence of self-ignition. Thus, the invention may be applied to any type of internal combustion engine provided that it is of a direct in-cylinder injection type.

1. (canceled)

2. A starting system as defined in claim 8, wherein:
when a compression-stroke cylinder as the subsequent cylinder which is in a compression stroke at the time of a start of the engine is stopped in the latter half of the compression stroke, the controller causes the fuel injector to inject the fuel into the compression-stroke cylinder in normal timing regardless of the temperature of the internal combustion engine; and
the controller retards the fuel injection timing for the compression-stroke cylinder to a point on or in the vicinity of the compression top dead center when the compression-stroke cylinder is stopped in the first half of the compression stroke and the temperature of the internal combustion engine is equal to or higher than the predetermined temperature.

3. A starting system as defined in claim 2, wherein the controller retards the fuel injection timing for the compression-stroke cylinder to a point slightly before the compression top dead center when the temperature of the internal combustion engine is equal to or higher than the predetermined temperature.

4. A starting system as defined in claim 8, wherein the controller retards the fuel injection timing for an intake-stroke cylinder as the subsequent cylinder which is in an intake stroke at the time of a start of the engine, when the intake-stroke cylinder is stopped in the latter half of the intake stroke and the temperature of the internal combustion engine is equal to or higher than the predetermined temperature.

5. A starting system as defined in claim 8, wherein:
the controller retards the fuel injection timing for the subsequent cylinder to a point slightly before the compression top dead center when the temperature of the internal combustion engine detected by the temperature sensor is equal to or higher than a first predetermined temperature; and
the controller retards the fuel injection timing for the subsequent cylinder to a point on the expansion stroke after the compression top dead center when the temperature of the internal combustion engine detected by the temperature sensor is equal to or higher than a second predetermined temperature that is higher than the first predetermined temperature.

6. A starting system as defined in claim 5, wherein:
when a compression-stroke cylinder as the subsequent cylinder which is in a compression stroke at the time of a start of the engine is stopped in the latter half of the compression stroke, the controller causes the fuel injector to inject the fuel into the compression-stroke cylinder in normal timing regardless of the temperature of the internal combustion engine;
the controller retards the fuel injection timing for the compression-stroke cylinder to a point slightly before the compression top dead center when the compression-stroke cylinder is stopped in the first half of the compression stroke and the temperature of the internal combustion engine is equal to or higher than the first predetermined temperature; and
the controller retards the fuel injection timing for the compression-stroke cylinder to a point on the expansion stroke after the compression top dead center when the compression-stroke cylinder is stopped in the first half of the compression stroke and the temperature of the internal combustion engine is equal to or higher than the second predetermined temperature.

7. A starting system as defined in claim 8, wherein after retarding the fuel injection timing for the compression-stroke cylinder or the intake-stroke cylinder as the subsequent cylinder, the controller resets the fuel injection timing for cylinders that follow the compression-stroke cylinder or the intake-stroke cylinder to normal injection timing.

8. A starting system of an internal combustion engine including a combustion chamber, an intake port and an exhaust port that communicate with the combustion chamber, and an intake valve and an exhaust valve that open and close the intake port and the exhaust port, respectively, comprising:
a fuel injector that injects a fuel into the combustion chamber;
an igniter that ignites an air/fuel mixture in the combustion chamber;
a crank angle sensor that detects a crank angle of the internal combustion engine;
a temperature sensor that detects a temperature of the internal combustion engine; and
a controller that:
determines an expansion-stroke cylinder that is in an expansion stroke at the time of a start of the engine, based on the result of detection of the crank angle sensor;
upon a start of the engine, causes the fuel injector to inject the fuel into the expansion-stroke cylinder, and causes the igniter to ignite the air/fuel mixture in the expansion-stroke cylinder, while causing the fuel injector to inject the fuel into a subsequent cylinder that follows the expansion-stroke cylinder, and causing the igniter to ignite the air/fuel mixture in the subsequent cylinder at or in the vicinity of a compression top dead center; and
retards the fuel injection timing for the subsequent cylinder when the temperature of the internal combustion engine detected by the temperature sensor is equal to or higher than a predetermined temperature.

9. A starting method of an internal combustion engine including (a) a combustion chamber, (b) an intake port and an exhaust port that communicate with the combustion chamber, (c) an intake valve and an exhaust valve that open and close the intake port and the exhaust port, respectively, (d) a fuel injector that injects fuel into the combustion chamber, (e) an igniter that ignites an air/fuel mixture in the combustion chamber, (f) a crank angle sensor that detects a crank angle of the internal combustion engine, and a temperature sensor that detects a temperature of the internal combustion engine, comprising the steps of:
determining an expansion-stroke cylinder that is in an expansion stroke at the time of a start of the engine, based on the result of detection of the crank angle sensor;
when the engine starts, causing the fuel injector to inject the fuel into the expansion-stroke cylinder, and causing the igniter to ignite the air/fuel mixture in the expansion-stroke cylinder, while causing the fuel injector to inject the fuel into a subsequent cylinder that follows the expansion-stroke cylinder, and causing the igniter to ignite the air/fuel mixture in the subsequent cylinder at or in the vicinity of a compression top dead center; and
retarding the fuel injection timing for the subsequent cylinder when the temperature of the internal combustion engine detected by the temperature sensor is equal to or higher than a predetermined temperature.

10. A starting method as defined in claim 9, wherein:
when a compression-stroke cylinder as the subsequent cylinder which is in a compression stroke at the time of a start of the engine is stopped in the latter half of the compression stroke, the fuel injector injects the fuel into the compression-stroke cylinder in normal timing regardless of the temperature of the internal combustion engine; and
the fuel injection timing for the compression-stroke cylinder is retarded to a point on or in the vicinity of the compression top dead center when the compression-stroke cylinder is stopped in the first half of the compression stroke and the temperature of the internal combustion engine is equal to or higher than the predetermined temperature.

11. A starting method as defined in claim 10, wherein the fuel injection timing for the compression-stroke cylinder is retarded to a point slightly before the compression top dead center when the temperature of the internal combustion engine is equal to or higher than the predetermined temperature.

12. A starting method as defined in claim 9, wherein the fuel injection timing for an intake-stroke cylinder as the subsequent cylinder which is in an intake stroke at the time of a start of the engine is retarded when the intake-stroke cylinder is stopped in the latter half of the intake stroke and the temperature of the internal combustion engine is equal to or higher than the predetermined temperature.

13. A starting method as defined in claim 9, wherein:
the fuel injection timing for the subsequent cylinder is retarded to a point slightly before the compression top dead center when the temperature of the internal combustion engine detected by the temperature sensor is equal to or higher than a first predetermined temperature; and
the fuel injection timing for the subsequent cylinder is retarded to a point on the expansion stroke after the compression top dead center when the temperature of the internal combustion engine detected by the temperature sensor is equal to or higher than a second predetermined temperature that is higher than the first predetermined temperature.

14. A starting method as defined in claim 13, wherein:
when a compression-stroke cylinder as the subsequent cylinder which is in a compression stroke at the time of a start of the engine is stopped in the latter half of the compression stroke, the fuel injector injects the fuel into the compression-stroke cylinder in normal timing regardless of the temperature of the internal combustion engine;
the fuel injection timing for the compression-stroke cylinder is retarded to a point slightly before the compression top dead center when the compression-stroke cylinder is stopped in the first half of the compression stroke and the temperature of the internal combustion engine is equal to or higher than the first predetermined temperature; and
the fuel injection timing for the compression-stroke cylinder is retarded to a point on the expansion stroke after the compression top dead center when the compression-stroke cylinder is stopped in the first half of the compression stroke and the temperature of the internal combustion engine is equal to or higher than the second predetermined temperature.

15. A starting method as defined in claim 9, wherein after retarding the fuel injection timing for the compression-stroke cylinder or the intake-stroke cylinder as the subsequent cylinder, the fuel injection timing for cylinders that follow the compression-stroke cylinder or the intake-stroke cylinder is reset to normal injection timing.
